(19) United States
(12) Patent Application Publication
(10) Pub. No.: US 2014/0067225 A1
(43) Pub. Date: Mar. 6, 2014

(54) DEVICE AND METHOD FOR CONTROLLING DRIVING OF A VEHICLE IN A COASTING SITUATION

(71) Applicants: HYUNDAI MOTOR COMPANY, Seoul (KR); KIA MOTORS CORPORATION, Seoul (KR)

(72) Inventors: Jeong Woo Lee, Hwaseong (KR); Seung Gil Choi, Yongin (KR); Jung Do Kee, Seoul (KR); Hee Gwon Kim, Hwaseong (KR)

(73) Assignees: KIA MOTORS CORPORATION, Seoul (KR); HYUNDAI MOTOR COMPANY, Seoul (KR)

(21) Appl. No.: 13/715,493

(22) Filed: Dec. 14, 2012

(30) Foreign Application Priority Data
Aug. 29, 2012 (KR) 10-2012-0094728

(51) Int. Cl. B60W 30/188

(52) U.S. Cl. CPC B60W 30/188
USPC 701/93

(57) ABSTRACT

Disclosed is a device and method for controlling driving operations of a vehicle in a coasting situation. The device may include a vehicle speed detector, a coasting drivable range operator, and a controller. The vehicle speed detector detects a current vehicle speed when signals from an accelerator position sensor and a brake pedal position sensor are both zero (0). The coasting drivable range operator determines whether or not coasting is possible by receiving a current location of the vehicle, road conditions and location information, and information related to an inter-vehicle distance when the current vehicle speed is equal to or greater than a certain speed. The controller turns off a motor in response to determining that the coating is possible when an inter-vehicle distance between the vehicle and a preceding vehicle is equal to or greater than a predetermined distance.

### CROSS-REFERENCE TO RELATED APPLICATION

This application claims under 35 U.S.C. §119(a) the benefit of Korean Patent Application No. 10-2012-0094728 filed Aug. 29, 2012, the entire contents of which are incorporated herein by reference.

### BACKGROUND

(a) Technical Field

The present invention relates to a device and method for controlling driving operations of a vehicle in a coasting situation. More particularly, the present invention relates to a device and method for controlling driving operations of an electric vehicle in a coasting situation, which can maximize a distance travelled by the electric vehicle using information related road and traffic conditions while driving.

(b) Background Art

Recently, with growing customer dissatisfaction regarding discrepancies between a certified fuel efficiency and an actual fuel efficiency, there has been an increasing concern on the importance of the actual fuel efficiency of a vehicle. Thus, technologies for maximizing the actual fuel efficiency based on a driver's actual driving conditions, such as current traffic congestion, and road conditions instead of those based solely on the vehicle system in a perfect environment have been more intensively studied and developed in the vehicle industry.

For example, a technology for finding and guiding an economic driving path using Information Technology (IT) and traffic information, a technology for guiding an effective fuel efficiency driving by storing information related to road slopes and previous driving patterns, a technology for controlling charging/discharging according to the State-of-Charge (SOC) level of a battery by predicting and determining road slope and traffic information, and a technology for selectively controlling driving mode so that fuel consumption can be minimized based on path and traffic information to a destination using map information database are being studied and developed. However, none of these systems or methods provide a measurement that is sufficient enough to satisfy the consumer's need to acute accuracy in this regard.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a device and method for controlling driving operations of an electric vehicle in a coasting situation, which maximizes the distance of the electric vehicle can travel on a single charge by identifying a coasting drivable range using various kinds of traffic information (e.g., traffic volume, traffic flow, etc.), road information (e.g., road slope, road curvature, intersections with stop signs or traffic signals, etc.) within a map information database, a location of the vehicle acquired through a global positioning system (GPS), and information acquired through an inter-vehicle distance sensor during actual driving, and by controlling a motor and a regenerative braking system by a controller (VCU) in the coasting drivable range to provide maximum efficiency.

In one aspect, the present invention provides a device for controlling driving of an electric vehicle in a coasting situation, including: a vehicle speed detector configured to detect a current speed of the vehicle when one or more signals from an accelerator position sensor (APS) and a brake pedal position sensor (BPS) are both zero (0); a coasting drivable range operator configured to determine whether or not coasting is possible by receiving a current location of the vehicle, road conditions and location information in a projected direction of travel, and information on an inter-vehicle distance when the current vehicle speed is equal to or greater than a particular speed; and a controller configured to turn on and off a motor configured to provide a driving force and regenerative braking in response to determining that the coasting is possible when an inter-vehicle distance from a preceding vehicle is equal to or greater than a predetermined distance based on a calculation executed by the coasting drivable range operator.

In an exemplary embodiment, the device may further include: a global positioning system (GPS) receiver configured to provide the current location of the vehicle to the coasting drivable range operator; a map information database stored either on a remote server in communication with the operator or on an internal hard driver or memory located within the vehicle, the map information database providing information related to the road conditions and location information including road slope, road curvature, and intersection information in the projected traveling direction of the vehicle; and an inter-vehicle distance sensor detecting and providing the inter-vehicle distance from a preceding vehicle.

In another aspect, the present invention provides a method for controlling driving of an electric vehicle in a coasting situation, including: determining, by the coasting drivable range operator, whether or not coasting is possible by receiving a current location of the vehicle from the GPS system, road conditions and location information in a projected travelling direction of the vehicle, and information related to an inter-vehicle distance when a current vehicle speed is equal to or greater than a particular speed; determining, by the operator, that a coasting mode is possible when an inter-vehicle distance from a preceding vehicle is equal to or greater than a certain distance; and turning off, by a controller in communication with the operator, a motor providing a driving force and regenerative braking in order to perform the coasting mode.

In an exemplary embodiment, the method may further include performing the regenerative braking by the motor by turning on the motor again once an acceleration of a vehicle is equal to or greater than zero (0) in the coasting mode.

In another exemplary embodiment, the method may further include cancelling the coasting mode when the inter-vehicle distance from the preceding vehicle is equal to or less than the certain distance in the coasting mode.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flowchart illustrating a device and method for controlling driving of an electric vehicle in coasting conditions according to an exemplary embodiment of the present invention; and

FIG. 2 is a view illustrating exemplary environmental conditions which should be to present in order for an operator to start coasting the vehicle.

FIG. 3 is a schematic diagram of the structural components of the exemplary embodiment of the present invention.

Reference numerals set forth in the Drawings includes reference to the following elements as further discussed below:
10: vehicle speed detector
12: vehicle speed sensor
20: coasting drivable range operator
22: GPS receiver
24: map information database
26: inter-vehicle distance sensor
30: vehicle controller
32: motor

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, exemplary embodiments of the present invention will be described in detail with reference to the accompanying drawings.

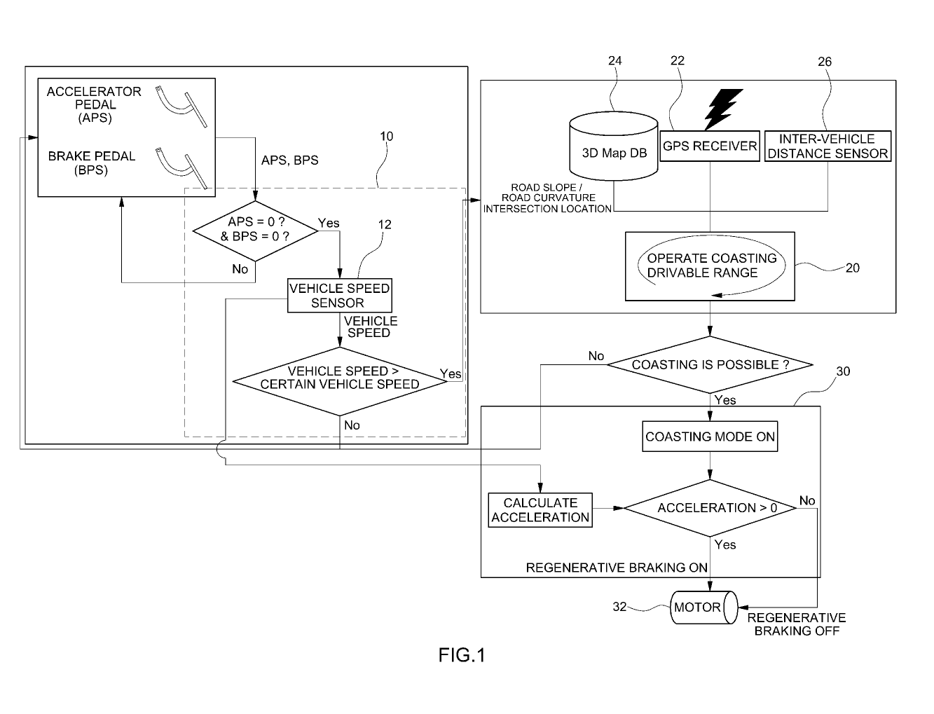

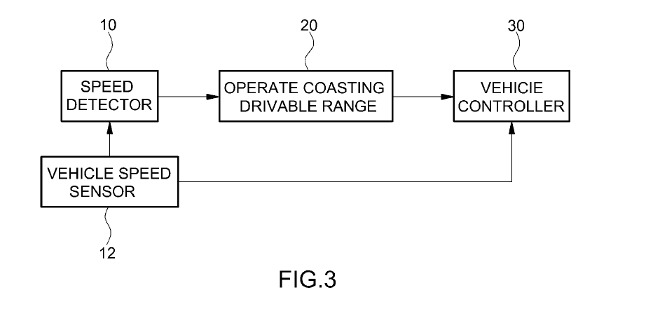

As shown in FIG. 1 and FIG. 3, a device for controlling driving operations of an electric vehicle in a coasting situation according to an exemplary embodiment of the present invention may include a vehicle speed detector 10 configured to detect a current speed of the vehicle based on receiving a signal from a vehicle speed sensor 12 and a coasting drivable range operator 20 determining whether or not coasting is possible when signals from an accelerator position sensor (APS) 13 and a brake pedal position sensor (BPS) 14 are both zero (0).

Also, in order to provide the coasting drivable range operator 20 with information related road conditions and traffic conditions, the coasting drivable range operator 20 may include a Global Positioning System (GPS) receiver 22 providing a current location of a vehicle, a map information database 24 (e.g., on a remote server or stored on an internal memory or hard drive located within the vehicle) providing road conditions and location information such as road slope, road curvature, and intersection information within the projected travel direction of the vehicle, and an inter-vehicle distance sensor 26 configured to detect and provide an inter-vehicle distance between the vehicle and a preceding vehicle. The operator 24 may be embodied as a controller that includes a processor and memory that are used to execute specific logic configured to perform the below operations of the operator. Furthermore, although this operator is described as being a separate controller, the operator 20 may also be integrated with the controller 30 without departing from the overall aspects of the present invention.

Accordingly, when the current vehicle speed is equal to or greater than a certain vehicle speed, the coasting drivable range operator 20 may determine whether or not coasting is possible by receiving the current location of the vehicle from the GPS receiver 22, the road conditions and location information in the projected direction of travel from the map information database 24, preferably, from a 3D map information database 24 including three-dimensional Map information, and information related the inter-vehicle distance from the inter-vehicle distance sensor 26.

From a calculation result of the coasting drivable range operator 20, when the inter-vehicle distance from the preceding vehicle is equal to or greater than a certain (threshold) distance, coasting may be determined to be possible. Then, the coasting drivable range operator 20 may deliver a control command that turns off a motor 32 that provides a driving force and regenerative braking to a vehicle controller 30 for controlling the motor 32. Thus, since the vehicle controller 30 turns off the motor 32 for simultaneously performing driving and regenerative braking, the vehicle can coast via inertia only, and simultaneously battery consumption can be reduced because the motor 32 is now off.

Hereinafter, a method for controlling driving of an electric vehicle in a coasting situation according to the exemplary embodiment of the present invention will be described in detail with reference to the accompanying drawings.

During actual driving, an accelerator position sensor (APS) 13 and a brake pedal position sensor (BPS) 14 may detect whether a driver is depressing an accelerator pedal or a brake pedal. When signals from the accelerator position sensor (APS) 13 and the brake pedal position sensor (BPS) 14 are both zero (0), the vehicle speed detector 10 may detect a current speed of a vehicle.

More specifically, when a driver is not pressing either the accelerator pedal or the brake pedal, both signals from the accelerator position sensor (APS) 13 and the brake pedal position sensor (BPS) 14 become zero (0). In this case, the vehicle speed detector 10 may determine whether or not the current vehicle speed detected by the vehicle speed sensor 12 is equal to or greater than a particular vehicle speed (e.g., a speed based on the vehicle's mass to determine the proper speed to provide sufficient momentum to allow the vehicle to coast).

When the current vehicle speed is equal to or greater than the particular vehicle speed, the coasting drivable range operator 20 may determine whether or not coasting is possible by receiving a current location of the vehicle, road conditions in the projected direction of travel, and an inter-vehicle distance, etc.

More specifically, when the current vehicle speed is equal to or greater than the particular vehicle speed, the coasting drivable range operator 20 may determine whether or not coasting is possible by receiving the current location of the vehicle from the GPS receiver 22, front road conditions including a road slope, a road curvature, and intersection information, as well as location information from the map information database 24, preferably, from the 3D map information database 24 having a three-dimensional map information, and an inter-vehicle distance between the vehicle and a preceding vehicle (if there is one present) from the inter-vehicle distance sensor 26.

From a calculation result of the coasting drivable range operator 20, when an inter-vehicle distance from the preceding vehicle (if present) is equal to or greater than a predetermined distance (described below), the coasting driving may be determined to be possible, and a command signal for performing a coasting mode may be delivered to the vehicle controller 30.

This particular distance refers to a distance from the preceding vehicle, and is determined based on vehicle speed, road slope, etc. The inter-vehicle distance may be a distance of X (e.g., in meters “m”)/Y (e.g., in kilometers per hour (km/h), for example, when the vehicle speed is Y km/h, the vehicle distance from the preceding vehicle should be at least cX m. Value ‘c’ is a constant which differs from vehicle to vehicle. On an uphill road, a value smaller than cX m is applied depending on the slope, whereas on a downhill road a value greater than cX m is applied depending on the slope.

Next, since the vehicle controller 30 turns off the motor 32 for simultaneously performing driving and regenerative braking, the vehicle can coast by inertia/momentum, and simultaneously battery consumption can be reduced since the motor 32 is off and no power is being utilized.

The vehicle controller 30 may deliver a regenerative braking-off command to the motor 32 so that the motor 32 does not perform necessary regenerative braking. In this case, the vehicle controller 30 may calculate the acceleration of the vehicle based on the vehicle speed signal from the vehicle speed sensor 12. When the acceleration is greater than zero (e.g., while going down hill on a road), the motor 32 may be again turned on so that the motor 32 performs the regenerative braking. Thus, the vehicle may be controlled so as not to be unexpectedly accelerated under the driving conditions such as while traveling downhill. While the vehicle is coasting, if the inter-vehicle distance detected by the inter-vehicle distance sensor 26 becomes shorter than the predetermined distance, the vehicle controller 30 may cancel the coasting mode accordingly.

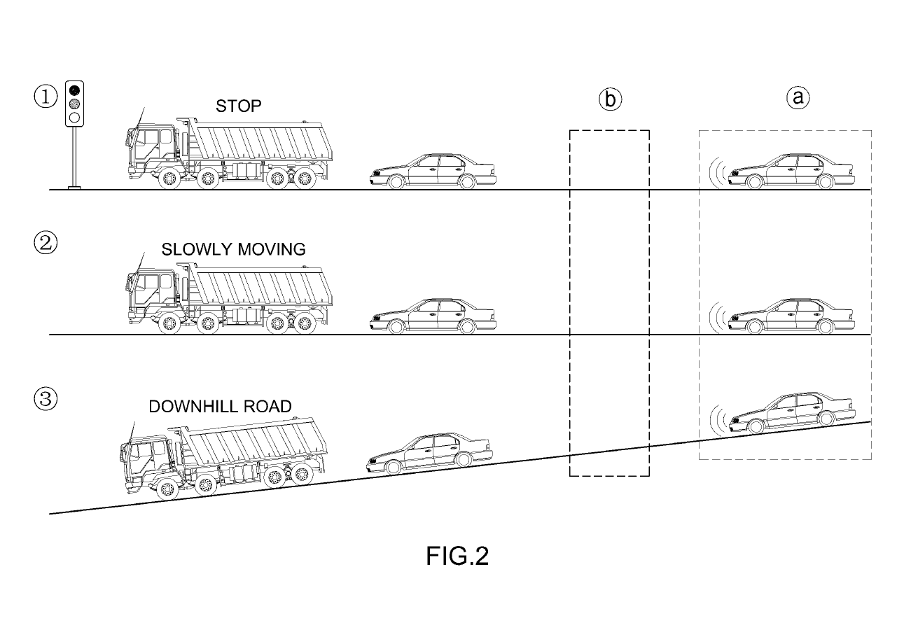

Hereinafter, an example of controlling driving in the coasting situation according to an embodiment of the present invention will be described in detail. As shown in FIG. 2, when there is an intersection (as shown in 1), another vehicle slowly moving (as shown in 2), or the road conditions are such that the vehicle is traveling down hill, a driver may take his/her foot off the accelerator pedal while at the same time not stepping on the brake pedal. In this case, when values of APS=0 and BPS=0 are detected by the accelerator position sensor (APS) 13 and the brake pedal position sensor (BPS) 14, and the vehicle speed detected by the vehicle speed sensor 12 is equal to or greater than a certain vehicle speed, the coasting drivable range operator 20 may receive a current location of the vehicle (location (a)) and information related to the road slope, road curvature and intersection information location in the projected traveling direction from present location received from a GPS.

Thereafter, based a calculation result of the coasting drivable range operator 20, when an inter-vehicle distance between the vehicle (in (a)) and a preceding vehicle delivered from the inter-vehicle distance sensor 26 is equal to or greater than the previously stored predetermined distance, the coasting drivable range operator 20 may determine whether or not the vehicle is operating in a coasting drivable situation, and may transmit a signal command to the vehicle controller 30 informing the vehicle controller 30 that coasting mode is possible.

The above calculation results are not used to calculate the Coasting Drivable Range, but to determine whether or not coasting driving is possible by receiving information on a current location of the vehicle, road conditions in the projected direction of travel, vehicle speed limit, a road slope, a road curvature, etc. For example, in the case when there is an intersection within 100 m from the vehicle and the vehicle is supposed to stop because of the red light according to the location information from the map information database 24, preferably, from the 3D map information database 24 having a three-dimensional map information, it is determined as a region not enabling a coast driving although the inter-vehicle distance is within a coast driving range.

In a coasting drivable situation, when the coasting mode is turned on by the vehicle controller 30, the acceleration may be calculated based on a speed value received from the vehicle speed sensor 12. In this case, when acceleration is equal to or less than zero, the vehicle controller 30 may allow the vehicle to be driven via kinetic energy of the vehicle without regenerative braking or a generated driving force by turning off the motor 32. On the other hand, when either the acceleration is greater than zero, or a distance between the vehicle and the preceding vehicle is measured to be or becomes equal to or less than the predetermined distance (location (b)) by the inter-vehicle distance sensor 26, the motor 32 may be again turned on to automatically perform regenerative braking.

Advantageously, according to the exemplary embodiment of the present invention, the fuel efficiency and the Distance to Empty (DTE) of an electric vehicle can be improved by utilizing a kinetic energy (momentum) of a vehicle as much as possible and minimizing energy consumption of a battery through non-power driving without unnecessary regenerative braking when an accelerator/brake is not needed by a driver. Also, since a powertrain system of an electric vehicle is controlled without separate manipulation by a driver using various kinds of IT information (e.g., road slope, road curvature, and traffic flow), GPS information, and inter-vehicle distance information, the driving convenience and stability of the overall operation of an electric vehicle can be increased.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A device for controlling driving of a vehicle in a coasting situation, comprising:
a vehicle speed detector configured to detect a current vehicle speed when signals from an accelerator position sensor (APS) and a brake pedal position sensor (BPS) are both equal to zero (0);
a coasting drivable range operator configured to determine whether or not coasting is possible based on receiving a current location of the vehicle, road conditions and location information in a projected travel direction, and information related to an inter-vehicle distance when the current vehicle speed is equal to or greater than a particular speed; and
a controller configured to turn off a motor which provides a driving force and regenerative braking in response to determining that the coasting is possible when an inter-vehicle distance between the vehicle and a preceding vehicle is equal to or greater than a predetermined distance.

2. The device of claim 1, further comprising:
a global positioning system (GPS) receiver configured to provide the current location of the vehicle to the coasting drivable range operator;
a map information database configured to provide information related to the road conditions and location information, the information including road slope, road curvature, and intersection in a projected travelling direction of the vehicle; and
an inter-vehicle distance sensor configured to detect and provide the inter-vehicle distance between the vehicle and the preceding vehicle.

3. A method for controlling driving of a vehicle in a coasting situation, comprising:
determining, by a controller, whether or not coasting is possible by the vehicle based on receiving a current location of the vehicle, road conditions and location information in a projected direction of travel of the vehicle, and information related to an inter-vehicle distance when a current vehicle speed is equal to or greater than a particular speed;
determining, by the controller, that a coasting mode is possible when an inter-vehicle distance between the vehicle and a preceding vehicle is equal to or greater than a predetermined distance; and
turning off, by the controller, a motor that provides a driving force and regenerative braking in order to perform the coasting mode.

4. The method of claim 3, further comprising re-activating the regenerative braking by the motor by turning on the motor again, by the controller, when an acceleration of a vehicle is equal to or greater than zero (0) in the coasting mode.

5. The method of claim 3, further comprising cancelling, by the controller, the coasting mode when the inter-vehicle distance between the vehicle and the preceding vehicle is equal to or less than the predetermined distance while the vehicle is in the coasting mode.

6. A non-transitory computer readable medium containing program instructions executed by a controller having a processor and memory, the computer readable medium comprising:
program instructions that determine whether or not coasting is possible by a vehicle based on receiving a current location of the vehicle, road conditions and location information in a projected direction of travel of the vehicle, and information related to an inter-vehicle distance when a current vehicle speed is equal to or greater than a particular speed;
program instructions that determine that a coasting mode is possible when an inter-vehicle distance between the vehicle and a preceding vehicle is equal to or greater than a predetermined distance; and
program instructions that turn off a motor that provides a driving force and regenerative braking in order to perform the coasting mode.

7. The non-transitory computer readable medium of claim 6, program instructions that reactivate regenerative braking by the motor by turning on the motor again, by the controller, when an acceleration of a vehicle is equal to or greater than zero (0) in the coasting mode.

8. The non-transitory computer readable medium of claim 6, further comprising program instructions that cancel the coasting mode when the inter-vehicle distance between the vehicle and the preceding vehicle is equal to or less than the predetermined distance while the vehicle is in the coasting mode.
